(19) United States
(12) Patent Application Publication
(10) Pub. No.: US 2009/0037978 A1
(43) Pub. Date: Feb. 5, 2009

(54) SELF-ADAPTIVE MULTIMODAL BIOMETRIC AUTHENTICATION METHOD AND SYSTEM FOR PERFORMANCE THEREOF

(75) Inventors: Jose Luque, Austin, TX (US); Carlos Siso, Coconut Grove, FL (US)

Correspondence Address: EDWARDS ANGELL PALMER & DODGE LLP, P.O. BOX 55874, BOSTON, MA, 02205, US

(73) Assignee: MERKATUM CORPORATION, Miami, FL (US)

(21) Appl. No.: 11/720,646

(22) PCT Filed: Dec. 20, 2005
(86) PCT No.: PCT/US05/46386

§ 371 Date: Jun. 1, 2007

Related U.S. Application Data
(60) Provisional application No. 60/639,188, filed on Dec. 22, 2004.

(51) Int. Cl. G06F 21/00

(52) U.S. Cl. 726/2

(57) ABSTRACT

A method for authentication of an individual based upon biometric mode and biometric instance data comprising the steps of: storing at least a first biometric data having at least one biometric data mode and at least two biometric data instances capable of identifying an individual associated with the first biometric data; creating an at least second biometric data having the at least one biometric data mode and the at least two biometric data instances capable of identifying a specific individual associated with the second biometric data; determining which of said at least one biometric data mode and said at least two biometric data instances are to be compared; in accordance with predetermined rules; and comparing the at least second biometric data to said at least first biometric data to determine whether the selected biometric data mode and selected biometric data instances of the at least first biometric data corresponds to the selected at least one of biometric data mode and selected at least two biometric data instances of the at least second biometric data.

### CROSS-REFERENCE TO RELATED APPLICATIONS

This application claims priority to U.S. Provisional Application Ser. No. 60/639,188, filed Dec. 22, 2004 entitled SELF-ADAPTIVE, RULE-BASED, MULTIMODAL BIOMETRIC IDENTITY AUTHENTICATION ENGINE.

### BACKGROUND OF THE INVENTION

There has been widespread adoption of biometric authentication for identification and verification of an individual. Biometric authentication as used herein is the method of utilizing a biological characteristic of an individual, such as retinal scan (“iris”), fingerprint, voice, facial features, handwriting, vein analysis, or the like.

It is known in the art to provide capture devices to scan, retain and manipulate biometric data. These may include iris or fingerprint pass-controlled access areas, or as is known in crime investigation, the use of fingerprints to identify an individual.

These systems have been satisfactory. However, they suffer from a disadvantage that in a significant number of individuals, at least one of the biometric data cannot be accurately or consistently utilized. For example, not all fingerprints may be legibly read. Handwriting may change from occurrence to occurrence, or may even be faked. Biometric data may be misread as a function of the quality of the scanning apparatus, which is not consistent from facility to facility. Because of the difference in algorithms which are utilized to process the scan to perform the verification and/or identification readings of a single instance of data can vary in quality and result from scan to scan.

Therefore, it has been proposed to utilize at least dual biometrics to identify and verify an individual based upon the use of at least two biometric readings. However, in the past, this alternative has been less than satisfactory because it has failed to recognize the difference in algorithm quality, image quality or even the inability to capture a second mode (type of biometric) from facility to facility. Some facilities may have fingerprint capability, yet the identification system is set up for comparing a combination of fingerprint and iris. Accordingly, practitioners, as a result of rigid biometric rules, have been forced to cram a square peg into a round hole.

Accordingly, a multimodal biometric authentication method and system which overcome the shortcomings of the prior art is desired.

### BRIEF SUMMARY OF THE INVENTION

A self-adaptive, rule-based multibiometric identity authentication engine provides a server associated with a database. The server is associated with at least one, facility, each facility having a plurality of sensors for capturing biometric data by capturing at least one biometric mode and at least two biometric instances utilizing at least one associated biometric algorithm for processing the biometric mode and biometric instance. The server creates a template associated with the captured biometric data and associated with an individual as an identifier of that individual. The template is then scored in accordance with rules. In a preferred embodiment, the values for each of the mode, algorithm and instance are normalized relative to each other and a fusion score is determined in accordance with the rules for the template.

The sensor captures at least one biometric mode data and at least two biometric data instances. The server creates a template of the captured mode and instance, scores the template in accordance with the rules, and compares the first template to a second template. The server confirms the identity of the individual if the first template compares to the second template with significance above a predetermined threshold value.

In a preferred embodiment, a quality score is assigned to each instance in the template to create a priority profile of the template. A comparison is made by comparing N biometric data modes and M biometric data instances of the first template and the second template. The modes and instances are selected from the template in priority of quality until the N×M requirement is satisfied. In a further preferred embodiment, the modes and instances are selected for comparison as a function of available scanners to capture the biometric data.

### BRIEF DESCRIPTION OF THE DRAWINGS

For a fuller understanding of the invention, reference is had to the following description taken in connection with the accompanying drawing in which:

FIG. 1 is a schematic view of a system utilizing the self-adaptive, rule-based biometric verification in accordance with the invention;

FIG. 2 is a flow chart of the method for self-adaptive, rule-based biometric verification in accordance with the invention;

FIG. 3 is a flow chart of the creation of the databases necessary for the matching engine in accordance with the invention;

FIG. 4 is a flow chart for the individual enrollment process in accordance with the invention;

FIG. 5 is a flow chart for the self-adaptive multibiometric authentication process in accordance with the invention; and

FIGS. 6a-6e are schematic representations of the logical organization of the databases in accordance with the invention.

### DETAILED DESCRIPTION OF THE INVENTION

The current invention provides enhanced identity authentication by utilizing at least two distinct biometric data. Biometric data may include the biometric data mode, the biometric data instances or the biometric data algorithm used for capturing and processing the mode or the instance. The biometric data mode relates to the type of biometric identifier being used such as face, fingerprint, iris, vein pattern, voice pattern or handwriting; i.e., any individually unique, but generic, physical characteristic which may be used to identify one individual from another. Biometric data instances relate to the specific biometric mode that is being captured and defined for a different sensed portion of the body. By way of example, instances of the biometric mode iris would be left iris and right iris. Distinct instances of the biometric mode fingerprint would be each finger printed. Furthermore, the instance is physiognomy specific in that the instance is a left index, as opposed to a right index or left thumb and iris is specifically left eye, right eye instances. The algorithm is a unique matching routine, which provides a match or no match result, as well as quality scores for the instances during enrollment and authentication procedures. For the purposes of this invention, mode may, but is not required to, include algorithms and the use of distinct algorithms would be the distinct instances.

It follows, that when monitoring or capturing the modes, that different sensor types are utilized for capturing different biometric modes, digital cameras capture facial identification characteristics, as compared to a fingerprint capture device, as compared to an iris capture device, or a handwriting capture device.

The present invention utilizes at least three of a mode and instances to better define, and compensate for shortcomings in algorithms, sensors, sensor availability and fraud to verify and identify individuals utilizing biometric data. The system is based on the utilization of at least one mode and that the number of modes and instances be greater than or equal to three.

By way of non-limiting example, a single mode such as fingerprint, but two instances may be utilized or two modes such as iris and fingerprint, but one instance for each may be utilized.

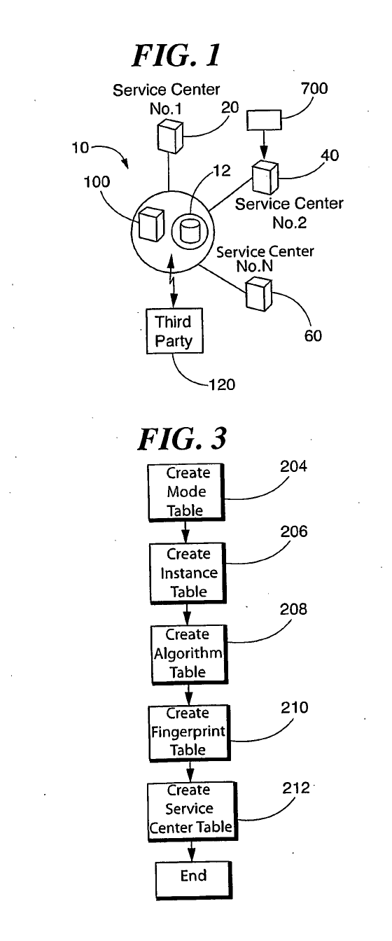

With that in mind, reference is now made to FIG. 1 in which a system for self-adaptive biometric authentication is provided. System 10 includes a server 100 for processing biometric data utilizing matching algorithms. Server 100 is associated with a biometric database 12, which, as will be discussed below, is a repository for biometric mode data, biometric instance data, and identification data which identifies an individual associated with the stored biometric data mode and biometric data instance. Service center data corresponding to the physical characteristics of particular service centers in communication with server 100 is also stored in database 12. By way of example, three service centers 20, 40 and 60 are shown. Each service center is provided with one or more biometric data capture devices. These devices are those known in the art which capture and digitize biometric mode and biometric instance data such as iris, fingerprint, facial, and the like.

In a preferred embodiment, each of service centers 20, 40 and 60 is remote from server 100. Server 100 may be any interactive device, which allows communication with scanners located at centers 20, 40, 60. The preferred embodiment is an Internet based system with encryption and appropriate firewalls. However, the system may include any device capable of performing an operation on digitized data to make a comparison between two sets of biometric data. Server 100 can communicate with the service centers by Internet, radio frequency, telephone, cable, handheld personal data accessory (“PDA”) or cellular phone by way of non-limiting examples.

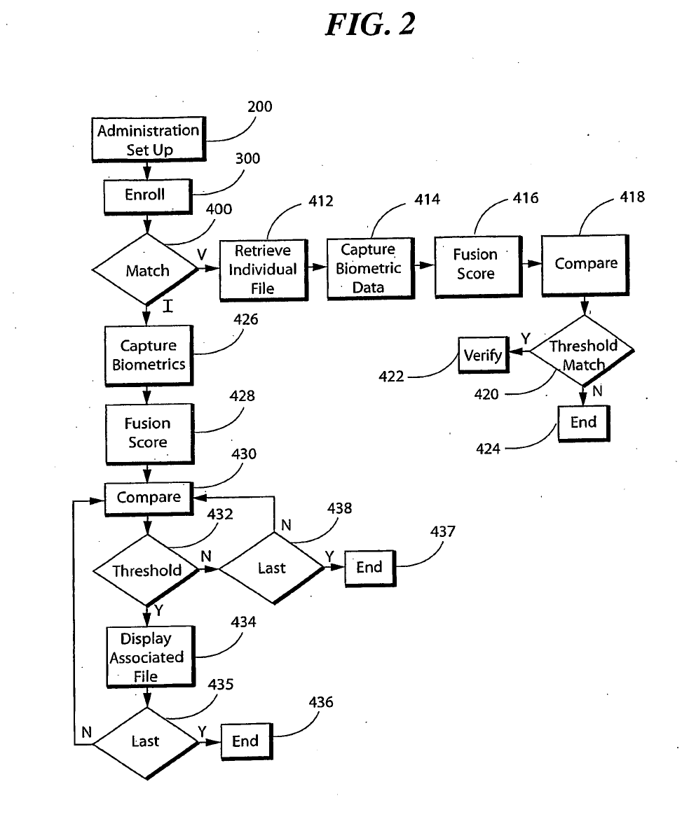

Reference is now made to FIG. 2 in which the overall process for authentication in accordance with the invention is provided. In a first step 200, the system is set up and initialized with the various biometric and service center data being stored in database 12. In a step 300, individuals are enrolled by capturing their biometric mode data and instance data and storing the data in database 12. In step 400, a match process is performed in which stored data is compared against live data obtained in real time at service centers 20, 40, 60.

Two types of authentication processing can occur: verification processing or identification processing. In a verification processing, a presented individual is being matched against the individual's own pre-stored file to verify or confirm their identity. In step 400, server 100 applies rules to database 12 and the biometric data presented at service centers 20, 40, 60.

Generally, if verification is to be determined, a record for the individual is already stored in database 12 and the individual's file is retrieved in a step 412. Biometric data for the individual is then captured at a service center 20, 40, 60 in a step 414. The captured biometric data is digitized and formed as a template to enable comparison with stored data. Normalization and fusion scoring (described below) is applied in a step 416 to the captured biometric data which is then compared in a step 418 to the data retrieved from database 12. A match is determined if in accordance with certain rules, a comparison score is above a threshold value, in a step 420. If a match has occurred, then a verification indication is provided in a step 422. If no match occurs, then the process ends in a step 424.

When trying to identify an individual without knowing their actual identification, comparisons are not made against a single known file, but against the entire anticipated population of biometric data stored in database 12. Therefore, in an identification process, the process begins in a step 426 by capturing the biometrics of an individual at a center 20, 40, 60. The captured data is then converted to a template, normalized and fusion scored in a step 428. In a step 430, it is compared to a data file corresponding to an individual as stored in database 12.

If the comparison yields a match at or above a threshold value, as determined in a step 432, then the associated file is displayed in step 434. It is then determined whether or not this is the last file in database 12. If yes then the process ends in a step 436. If not, then the process is repeated at step 430 until each file in database 12 has been compared. If more than one file corresponds to a match, it can be determined whether or not a single individual has recorded biometric data corresponding to a number of aliases, or the process may be fine-tuned to narrow down the number of “positive” matches.

Alternatively, if the comparison in step 430 does not exceed the predetermined threshold of step 432, it is determined in a step 438 whether the last file has been read from database 12. If yes, the process ends. If not, the process is repeated with another comparison at step 430.

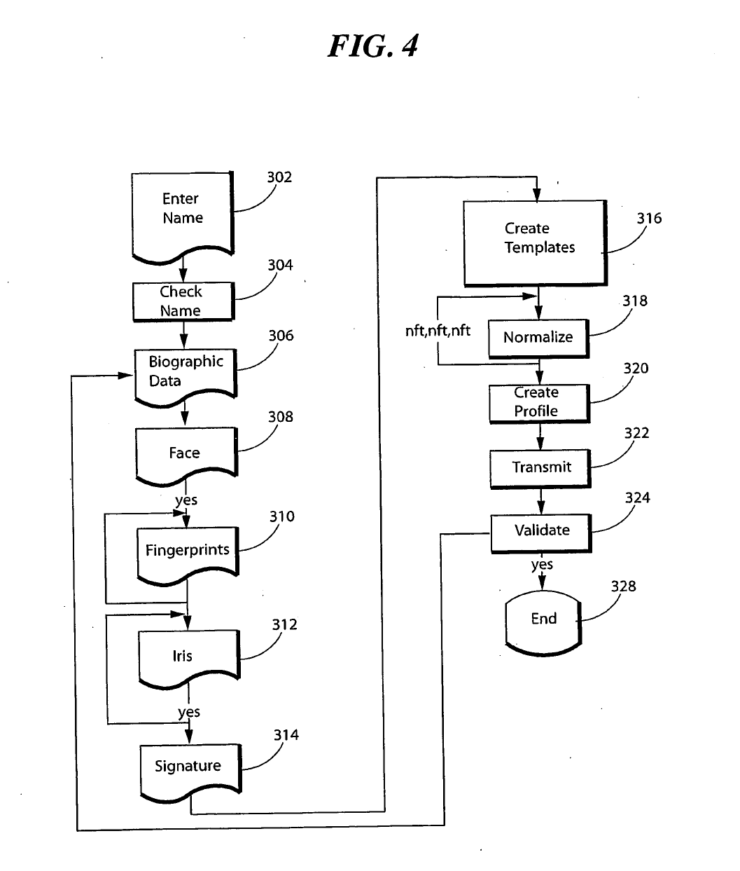

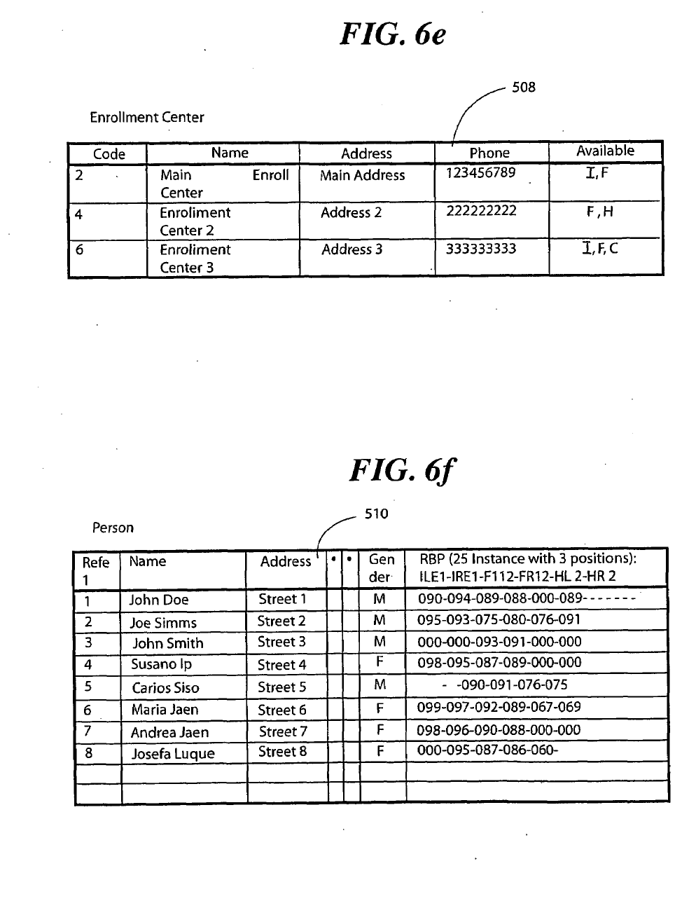

Reference is now made to FIGS. 3 and 6 wherein the administrative setup process 200 is shown in greater detail. In a step 204, a biometric mode table 500 (see FIGS. 6(a-b)) is stored in database 12 with corresponding identifier codes. In this non-limiting example, the modes are iris, fingerprint, face, hand and signature. The instances as stored in table 502 are respectively left eye (LE) and right eye (RE) for the iris (I) mode. The instances for fingerprints may be as high as 10, but for simplicity and ease of description, in this embodiment, left index (LI), right index (RI), left thumb (LT), and right thumb (RT) are utilized. That is four instances of the fingerprint mode. Face mode (C) has a single instance as does signature (S). The hand mode (H) has a corresponding left hand (L) and right hand (R) instance. Accordingly, the biometric data instances and biometric data modes of interest to be utilized by the engine are stored in the database in steps 204, 206.

Each mode requires an algorithm for processing. Algorithms for processing biometric mode and instance data are well known in the art, and in fact are common off-the-shelf software products (COTS). Each algorithm does not process mode data identically to another algorithm for the same mode. Furthermore, processing of iris mode instances is very different than processing fingerprint or facial mode instance data.

Furthermore, each algorithm scores the matching and capture results on a scale to be utilized to determine whether or not a proper match has occurred. The scale extends from a minimal possible score almost always nominally zero to a maximum possible score. These vary from algorithm to algorithm across modes and across instances. The algorithms along with their associated parameters are stored in database 12 in table 504 in accordance with a step 208 as shown in FIG. 6(c). The algorithm data as seen in FIG. 6(c) is identified as Iris COTS algorithm 1, fingerprint COTS algorithm 2 or face COTS algorithm 3. As shown in 6(d), a stored table 506 maps mode and instance to the appropriate mode instance algorithm combination. Furthermore, as will be discussed in greater detail below, each mode is assigned a weight for fusion scoring. The higher the weight, the more reliable and important the relative mode and/or instance.

In a step 210, data regarding individuals is stored in database 12 in a table 510 as part of the enrollment process to be discussed in greater detail below. However, as shown in FIG. 6(f), the individual data tables will assign a reference number to each individual associated with the person's name, and instance-specific mode scores. So, for example, in the first chart, John Doe has specific scores for 25 instance across three modes. By way of example, he has an iris left eye score of 90 and iris right eye score of 94 and a fingerprint left index finger of 89. He has a left hand score 0 showing that no left hand data was taken or that the normalized scoring of the captured image was insignificant.

Lastly, in a step 212, enrollment center databases are created. Much like biometric data, no two centers are alike, nor can they be anticipated to be alike. Therefore, as shown in FIG. 6(e), enrollment centers are identified by an enrollment center identification code, physical address of the enrollment center, phone number, communication information, as well as the modes available for capture and use at a particular enrollment center are stored in database 12 as table 508. By way of example, enrollment center 20 is capable of iris and fingerprint biometric data mode processing, but not hand or face. By comparison, enrollment center 40 is capable of processing fingerprint and hand biometric data mode, but not iris. Enrollment center 60 is capable of capturing and processing iris, fingerprint, hand and facial biometric data modes. Database 12 is now ready for use by server 100 as will be described in greater detail below.

The data as stored in database 12 is shown in the form of tables. These are merely representative by way of example only for ease of discussion, but data may be stored as single templates, as files, individual databases with cross pointing indicators or in any format allowing storage and use of data as described herein, or the like as known in the art.

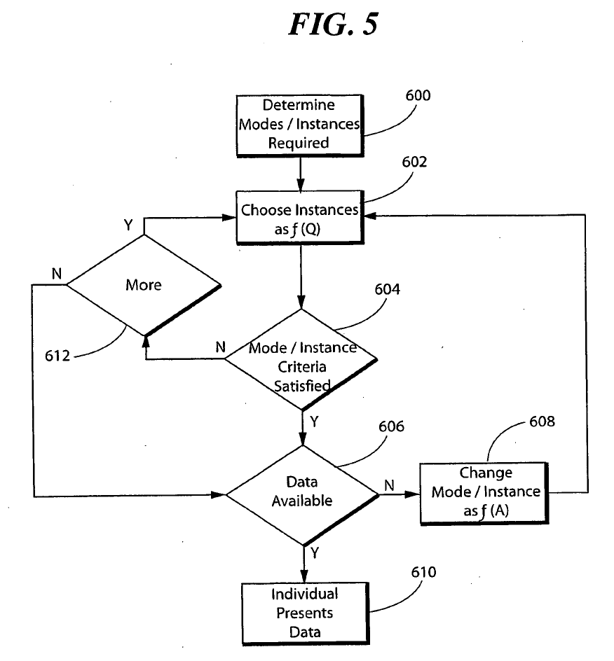

Reference is now made to FIG. 4 where the steps for the enrollment process are shown. An individual will report to a service center 20-60 for the capturing of biometric data and storing the data in database 12. In a step 302, the individual presents some type of identification document, such as a passport, driver's license, birth certificate or document having some unique identification number, such as social security number, voter registration number, tax ID or the like. In a step 304, a name or ID number check may be performed to determine whether or not such a person is already enrolled in the system. In this way, fraudulent issuance of documents, or fraudulent creation of files is prevented. It may also be used as a means for identifying or capturing individuals who have committed crimes. The identifying name or number information is compared to the files stored in database 12.

In a step 306, biographic data is input to the system for storage in the personal data files 510. Such data may be the address of the person, or as detailed as life history information.

As a function of the biometric capture devices available at the respective service centers 20, 40, 60, or the level of biometric protection or verification needed for particular applications, the biometric capture process begins. For thoroughness of explanation, this example assumes that face, fingerprint and iris and signature biometric data may be captured and are necessary for the application. However, it is well within the contemplation of the invention to capture more biometric data or less biometric data when creating table 510.

Therefore, in a step 308, to satisfy the F biometric data mode, a photograph of the face is taken. It is understood that a quality check is performed at each step to make sure that the quality of the captured biometric data instance reaches at least a minimal level. However, in some instances, biometric data cannot be sufficiently captured. By way of example, it is believed that two percent of United States citizens have fingerprints that cannot be correctly captured. With respect to the face, the use of a digital camera or illumination on a particular day at the center may make the capture of useful facial mode biometric data impossible.

Once a face is captured, fingerprints are captured in a step 310. The process is repeated the nft times corresponding to the number of required instances. For fingerprinting, that can be from zero through ten.

In a step 312, iris information is captured. This process is repeated nit times, which is either 1 or 2, to make sure that the required number of iris mode instances are captured.

Lastly, in a step 314, the signature is captured.

For each of the biometric instances, a template is created in a step 316. The template is the digitized image as captured by the COTS algorithms.

As discussed and as seen in table 504 of FIG. 6(c), each algorithm has a different scoring logic and value. Therefore, in order for the biometric data to be used across modes and across instances, the data is normalized. Normalization is necessary before the raw scores originating from the capture devices can be utilized. In a preferred embodiment, the min-max method maps the raw score to a 0, 1 range where n=s−min(S)/max(S)−min(S), where s equals the actual score and min(S) is the lowest range score and max (S) equals the highest range score.

It should be understood that other methods may be utilized as known in the art such as the z score, Tanh and adaptive normalization methods by way of example.

The quality of each captured instance is also determined utilizing known algorithms, normalized and given a score, which is stored as part of the personal database of the individual as a quality profile of the template.

In a step 320, a full biometric profile for the individual which includes the biometric templates, quality scores and normalized scores is created for each individual. Because of the sensitivity of this information and the need to transmit it from remote locations, the data may be compressed and encrypted as known in the art. Furthermore, biographic data may be added to the biometric profile to create a personal data packet associated with that individual's biometric data. The template is then transmitted to database 12 for storage in a step 322. For security, data may be validated in a step 324. If the data is not valid, then the entire process is repeated from step 306 by way of example. If the data is valid, then the process ends in step 328.

Once the system has been initialized, i.e., the center profiles are established, the algorithms to be used are established, the normalization techniques are established and individuals are enrolled, rules are established for determining matches between scanned individuals at a center 20, 40, 60 and the biometric data stored at database 12.

Referring again to FIG. 2, in a step 400, matching is performed. Matching, in its most generic sense, compares a presented biometric data to a stored biometric data. Matches are determined by the correspondence between the data found in one template as compared to another template. A threshold score is utilized. If the comparison results in a score above (or equally below if inverted) the threshold score, then a match is considered to have occurred.

As discussed above, the digitized biometric data, when operated upon by algorithms is in fact scored. Normalization occurs to place the different algorithms used and the different biometric modes within the same range of scoring. However, rules must be applied as the biometric modes, algorithms and instances lend themselves to different factors of reliability. In other words, each of the modes and instances is weighted against each other. By way of example, the inventors have noted that iris identification mode is at least 10 times as reliable as fingerprints, which in turn is at least 10 times as reliable as the facial biometric mode; quality of the captured biometric data being equal. Accordingly, one of the rules applied during the matching step 400 is a fusion method; combining the scores of non-alike modes and instances to determine a match. In this way, multimodal biometric identification and verification may be performed increasing the accuracy of already highly accurate COTS algorithms. The fusion operation combines the modal scores at the representation level to provide higher dimensional data points when producing the matched score.

This type of fusion score matching combines the individual scores from multiple matching algorithms. There are three levels at which fusion decision scoring can be applied. At a decision level, fusion scoring will determine which characteristic should be controlling. In other words, iris, when available, will be the characteristic of choice, then fingerprint, then facial, on down the line, as a function of the matcher's decision regarding which biometric modes to rely upon. At a score level, fusion matching utilizes a weighted average of the normalized score. For example, by way of non-limiting example, as shown in table 506, the iris normalized score may be multiplied by 5, the fingerprint normalized score may be multiplied by 3 and the normalized facial score may be multiplied by 2. In the preferred embodiment, the matching step utilizes score level weighted average fusion scoring.

Image level fusion scoring creates a template, which is a combination of all of the captured biometric images. An algorithm is applied to digitally combine each of the individual's captured images to create a single digital template (combined image). Matching algorithms are then compared on a template-by-template level. Fusion scoring can be applied at the weighting stage of creating the image, or after the image is created as a function of the constituents in the image.

Furthermore, each end user determines which biometric data is to be of interest. In extremely high security instances, where sophisticated readers are available, verification may include one, if not both, iris scans, in addition to fingerprint and facial. In more common utilizations, such as background check, two or more instances of fingerprint may be all that is required or a single fingerprint using more than one algorithm may suffice. Accordingly, the end user, in accordance with their needs, will set the number of modes and instances. However, for operation of the multibiometric verification in accordance with the present invention, at least one mode and at least two instances must be utilized for verification and to apply fusion scoring.

The compare step is performed as discussed above in FIG. 2 in which fusion scoring, identical to the fusion applied to stored data is applied to the live captured biometric data and compared with biometric data stored in database 12. However, in some instances, either each of the required modes are not obtainable, the quality of certain modes and instances is below the quality threshold, therefore making those captured images inconsequential, or the desired algorithm is unavailable. Therefore, the system must be self-adaptive in order to effectively perform verification identification when sufficient, but not the optimally desired, biometric data is available.

Where the desired number or quality of modes and instances is not available for use, server 100 determines the modes and instances to be used for fusion scoring and comparison as a function of the quality of the captured image templates.

As noted above, each captured instance of biometric data has an individual quality score. The quality of each instance is stored as a part of a quality profile for the template. Server 100 ranks the quality of each instance within each individual profile as stored in Table 510. Zeros would be the lowest quality with 100 being the highest quality by way of example. As discussed above, for reliability the iris mode is more reliable than the fingerprint mode which is more reliable than the face mode. However, if the iris mode is poor quality and the fingerprint mode is of higher quality, then the rules could be set so that the fingerprint mode could control. Furthermore, if the entire biometric data file is available and includes the fingerprint mode data, iris mode data and facial mode data, yet the application currently being applied does not require iris mode data, then the highest quality fingerprint data would be utilized. Conversely, if the application requires an iris identification, and none is available because none was originally taken or cannot be taken due to the limitations of the service center, then match rules can be set by the end user to rely on the next biometric mode and instance of highest quality and availability.

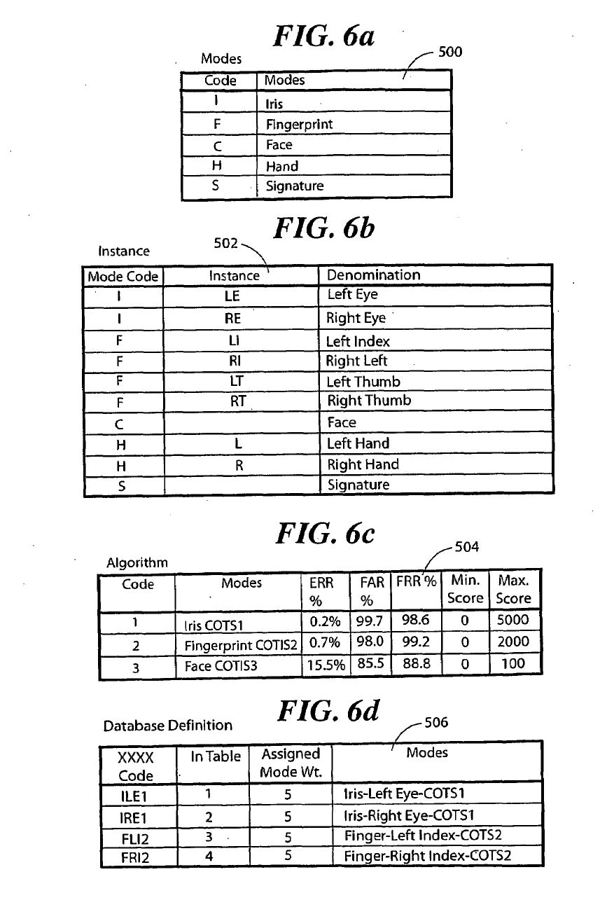

Specifically, turning to FIG. 5, the method for self-adaptive matching is provided. In a step 600, the number of N modes and M instances required is determined. This is usually set by the entity seeking authentication. In a step 602, the image of highest quality is selected from the template. This determines the first mode and first instance. In other words, a first mode and instance is selected from the template of interest as a function of quality of the instance.

In a step 604, it is determined whether or not the mode/instance criteria have been satisfied. In other words, if the verification requires two modes and three instances, such as fingerprint and iris, during the first iteration only a first mode and first instance would have been selected. Accordingly, step 602 would be repeated to choose a second instance and/or mode.

Additionally, if the mode instance criteria are not satisfied, then in a step 612, it is determined whether or not there are any more instances which may be utilized to satisfy the criteria. If not, the process moves on to step 606 regarding availability of data as will be discussed in greater detail below. If there are more instances to be selected, then in step 602 the second highest quality instance, regardless of mode, is selected. However, if the second highest quality is the same mode as the instance of the highest quality, only a single mode with two instances will have been selected and the mode/instance criteria will not be satisfied. So as long as there are still more instances available, even if the total number of modes plus instances is satisfied, if either the mode criteria is not satisfied or the instance criteria is not satisfied, step 602 will keep repeating until a mode of lower quality has replaced a mode/instance of higher quality to satisfy the mode/instance criteria in step 604.

Once the mode/instance criteria have been satisfied, or if the criteria have not been satisfied, but there are no more instances as determined in step 612, in a step 606, it is determined whether or not the data from the individual as captured at the center is available. In other words, in our two mode iris/fingerprint example, is there an iris reader and fingerprint reader available to the individual so that they can present the biometric data. If not, then rules are applied to change the mode/instance requirement to a purely qualitative requirement. In other words, select the three instances of highest quality in a step 608 and the unavailable instance or mode will be replaced in step 602 by the next highest quality instance or mode. If the data can be captured, i.e., the individual is capable of presenting the biometric data at the center, and the individual presents the biometric data at a step 608, a comparison is made as discussed above.

In a concrete non-limiting example, if two mode and three instances are required in a step 600 and a biometric database includes 10 fingers, the left iris and the face images forming the template, the instances are ranked in accordance with the quality of the captured image. So that in this example, the quality ranking is as follows: left index fingerprint, left iris, right thumb print, face, . . . left pinkie (as the image of lowest quality). The mode requirement determined as preset will be two modes, three instances.

Generally, as discussed above, iris is of more value than fingerprints, which is of more value than facial data. However, the rules can accommodate such a ranking in which mode is searched first, then quality within the mode, for selection in step 602. In such an instance, if the mode were not available, the system, if acceptable to the end user who sets the rules for the application would accept an additional instance of a lower weighted mode as a replacement for a single instance of a higher weighted mode or the like.

In step 602, instances are chosen as a function of quality. Because we have two modes and three instances, and the highest quality biometric data instance is the index finger, the index finger will be chosen as the first biometric data to be utilized. One mode and one instance has now been accounted for.

In a step 604, it is determined whether the mode/instance criteria are satisfied. Because two modes and three instances are required, step 602 (choosing) must be repeated. Because there is still more available data within the profile as determined in a step 612, step 602 is repeated.

The second highest quality biometric data is the left iris. That is chosen as the second biometric data to be used so that now two modes and two instances are accounted for. The process is repeated as server 100 moves down the list of the priority profile and utilizes the right thumb as the third highest quality biometric data. Now that the mode/instance criteria have been satisfied, in step 606 it is determined whether that data is even available from the individual of interest as a function of the service center. Server 100 scans the service center profile data to determine which modes are available. If in fact iris and fingerprint are available at that service center, the individual presents their data by presenting their fingerprint and their iris in step 610 and a verification or identification process is performed.

If, for example, there is no iris capture device at the center, then in step 608 the rules are changed to a default to utilize the next highest quality of the first mode, changing the criteria to one mode 3 instances or default to one instance of a second mode which in this case would be face. Therefore, the face, having the fourth highest quality would be chosen in step 602 to fulfill the 2 mode 3 instance criteria. The steps are then repeated until an individual is capable of presenting biometric data acceptable to the end user interested in the verification or identification. The matching then continues in accordance with steps 416, 426 as discussed above.

It should be noted that the above example was discussed in connection with biometric data mode in biometric data instances in which the mode was a type of biometric data. However, the method could easily be applied to the use of distinct algorithms as the instances of a mode so that a fingerprint utilizing a first algorithm is a first mode instance and a same fingerprint utilizing a second matching/capture algorithm fulfills the second mode instance in either algorithm or a second finger would satisfy the ⅔ mode algorithm requirement. Furthermore, by utilizing a self-adaptive scheme as a function of quality and/or availability highly reliable biometric authentication is available.

Furthermore, it should be noted that in the above embodiment it was determined whether the number of modes and instances required in the operation was performed as a function of quality in the first instance and a function of availability in the second instance. However, this order can be reversed as availability corresponds to a defacto lowest quality reading such that it is first determined which biometric data will be available, and those modes which are not available are automatically ignored from the profile when choosing instances as a function of quality.

Furthermore, it should be noted that what is inherent in step 602 is that if all fingerprints have a higher quality than iris, in the contemplated embodiment, once a single mode and two instances have been provided, unless an override rule is provided the default would be to skip the remaining fingerprint instances to the highest quality iris to fulfill the mode requirement ahead of the instance requirement. However, the logic could just as easily be mode indifferent and satisfy the instance requirement with the highest quality.

To facilitate discussion, the system 10 was described as a closed universe in which the database was created and stored by server 100. However, server 100 may make use of third-party databases some of which, such as the United States Federal Bureau of Investigation, or other law enforcement related algorithms and databases may perform their own comparison and return the data back to server 100 for use. Such a third-party provider 120 may communicate with server 100 by telephone, wireless communication, the Internet, or the like which allows the two-way communication of data between third-party 120 and server 100. By way of example, the Federal Bureau of Investigation's large-scale automated fingerprint identification system (AFIS) could receive and process the captured fingerprint information and return a matching result to server 100. Server 100 would then enhance the fingerprint only result by incorporating that into the fusion scoring and comparison of other biometric modes and instances.

In another embodiment, system 10 under the control of server 100 may manage the access to restricted information or restricted areas utilizing a verification triggered lock, or an ID card issuance management system. In this way, biometrically enabled identification documents such as passports, driver's license, benefit program cards and corporate credentials can be created and checked for fraud. First, during the enrollment process discussed above server 100 may determine if an individual has been previously issued an ID card by the system so that second-corners cannot fraudulently obtain such cards under someone else's name or identification.

Furthermore, because biometric data templates may be digitally stored in a magnetic stripe, barcode or radio frequency chip incorporated into the card, server 100 may perform the verification check as described above as the person holding the card is carrying their own defacto database. However, both the card and the live presented biometric data, which is compared to the card, may be simultaneously compared to database 12 created at card creation. In this way, fraudulent uses such as altered cards may be detected. Such cards, either standing alone or linked to database 12 may be utilized to control physical access to secured areas, or virtual access such as in a card and reader-controlled computer console. In other words, a biometric scanner and card reader may be affixed to a door, or to an activation control for equipment such as a computer or access-limited machinery. The smart card is loaded to the reader and only those individuals having biometric data identified with authorization to access the facility or equipment will be able to authorize access to such facility upon the live capture of the required modes and instances.

Finally, system 10 was described in connection with fixed centers at which verifications and/or identifications would occur. However, image capture for biometric data may also be obtained from a mobile device. By way of example, a device such as a Data Strip® DSVII®-SC Smart Card Reader includes a fingerprint sensor for capturing multiple instances of the fingerprint biometric mode which may be utilized as discussed above for verification at a mobile location.

It should be noted that the above example was utilized in connection with a pre-stored database of biometric data files as compared to a live capture of biometric data at a service center. However, the algorithms, rules, fusion scoring and authentication processes of the invention can be as easily applied between a first stored template and a second stored template of biometric data.

Thus, while there have been shown common described and pointed out novel features of the present invention as applied preferred embodiments thereof, it would be understood that various omissions and substitutions and changes in the form and detail are contemplated so that the disclosed invention may be made by those skilled in the art without departing from the spirit and scope of the invention. It is the intention therefore to be limited only as indicated by the scope of the claims appended hereto. It is also to be understood that the following claims are intended to cover all of the generic and specific features of the invention herein described and all statements of the scope of the invention which as a matter of language, might be said to fall therebetween.

What is claimed as new and desired to be protected by Letters Patent of the United States is:

1. A method for authentication of an individual based upon biometric data mode and biometric data instance comprising the steps of:
storing at least a first biometric data, having at least one biometric data mode and at least two biometric data instances, capable of identifying an individual associated with the first biometric data;
creating an at least second biometric data, having at least one biometric data mode and at least two biometric data instances, capable of identifying a specific individual associated with the second biometric data;
determining which of said at least one biometric data mode and said at least two biometric data instances are to be compared in accordance with predetermined rules; and
comparing the at least second biometric data to said at least first biometric data to determine whether the selected biometric data mode and selected biometric data instances of the at least first biometric data corresponds to the selected at least one biometric data mode and selected at least two biometric data instances of the at least second biometric data.

2. The method of claim 1 further comprising the step of converting said at least first biometric data into a first template and converting said at least second biometric data into a second template, and comparing the first template to the second template to determine whether the at least first biometric data corresponds to the at least second biometric data.

3. The method of claim 1, wherein N biometric modes and M biometric instances are selected to be compared, and N is less than M.

4. The method of claim 2 wherein said biometric data mode is scored and said biometric data instance is scored, and said scores are normalized.

5. The method of claim 1, wherein said predetermined rules include scoring each biometric data mode and each biometric data instance by applying a weighted average to each of said at least one biometric data mode and at least two biometric data instances for said at least first biometric data and said at least second biometric data prior to comparing the at least second biometric data to said at least first biometric data.

6. The method of claim 1, wherein said biometric data mode includes at least one of algorithm, iris, fingerprint, face, handwriting, and voice.

7. The method of claim 1, wherein the predetermined rule includes determining the at least one biometric data mode and the at least two biometric data instances to be compared as a function of quality of each biometric data instance.

8. The method of claim 1, in which the predetermined rule includes determining the at least one biometric data mode and the at least two biometric data instances to be compared as a function of the availability of the at least one biometric data mode as an element of the at least first biometric data and the at least second biometric data.

9. The method of claim 1, wherein said at least second biometric data is created by an individual presenting biometric data to a biometric data scanning device.

10. The method of claim 9, wherein the physical location of the creation of said second data file is remote from the physical location of where the comparing of the at least second biometric data to said at least first biometric data takes place.

11. The method of claim 10, wherein said at least second biometric data is created utilizing a mobile biometric data capture device.

12. The method of claim 10, wherein said at least first biometric data is stored at a location remote from said location where said first biometric data is compared to said second biometric data.

13. The method of claim 1, wherein said comparing of the at least second biometric data to said first biometric data further comprises the step of fusion scoring said first biometric data and said second biometric data.

14. The method of claim 13, wherein said fusion scoring further comprises the step of applying weighted averages to said at least one biometric data mode and said at least two biometric data instances.

15. A system for authentication of an individual based upon a biometric data mode and biometric data instance comprising:
a server;
a database associated with the server, a first biometric data having at least one biometric data mode and at least two biometric data instances capable of identifying an individual associated with the first biometric data being stored in said database;
a service center, in communication with said server, said service center creating at least a second biometric data having at least one biometric data mode and at least two biometric data instances capable of identifying a specific individual associated with the second biometric data and transmitting said biometric data to said server, said server determining which of said at least one biometric data mode and said at least two biometric data instances are to be compared in accordance with predetermined rules, and comparing the at least second biometric data to said at least first biometric data to determine whether the selected biometric data mode and selected biometric data instances of the at least first biometric data correspond to the selected at least one biometric data mode and selected at least two biometric data instances of the at least second biometric data.

16. The system of claim 15, wherein said server converts said at least first biometric data into a first template, and compares the first template to a second template corresponding to said second biometric data to determine whether the at least first biometric data corresponds to the at least second biometric data.

17. The system of claim 16, wherein said service center creates said second template.

18. The system of claim 17, wherein said server creates said second template.

19. The system of claim 15, wherein said server selects N biometric data modes and M biometric data instances to be compared between said first biometric data and said second biometric data.

20. The system of claim 16, wherein said first template is scored and said second template is scored and said scores are normalized.

21. The system of claim 16, wherein a weighted average is applied to each of said at least one biometric data mode and at least two biometric data instances of said first template and said at least second template prior to comparing said at least second template to said at least first template.

22. The system of claim 21, wherein said server determines a quality profile for each of said at least first template and said at least second template and the at least one biometric data mode and the at least two biometric data instances to be compared as determined as a function of the quality of each instance of biometric data instances as determined from said templates.

23. The system of claim 15, wherein said server determines the availability of at least one biometric data mode as an element of the at least first data and the at least second data and determines which of said at least one biometric data mode is to be compared as a function of the availability of the biometric mode data.

24. The system of claim 15, wherein said service center is a mobile biometric data capture device.
